(19) United States
(12) Patent Application Publication
(10) Pub. No.: US 2004/0233317 A1
(43) Pub. Date: Nov. 25, 2004

(54) Imaging device for microscope

(75) Inventor: Shinji Matsushita, Ome-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/621,843

(22) Filed: Jul. 16, 2003

(30) Foreign Application Priority Data
Jul. 22, 2002 (JP) 2002-212860

(51) Int. Cl. H04N 5/222

(52) U.S. Cl. 348/333.02

(57) ABSTRACT

An imaging device for a microscope comprises an electronic camera which images an observation image captured by the microscope, a display which displays an observation image imaged by the electronic camera and photograph information of the observation image, and a display setting portion which controls the display to set display of the photograph information.

### CROSS-REFERENCE TO RELATED APPLICATION

This application is based upon and claims the benefit of priority from the prior Japanese Patent Application No. 2002-212860, filed Jul. 22, 2002, the entire contents of which are incorporated herein by reference.

### BACKGROUND OF THE INVENTION

1. Field of the Invention

The present invention relates to a microscope system, and more particularly to an imaging device for a microscope used for imaging an observation image captured by that microscope.

2. Description of the Related Art

As a method for displaying imaging information on an image, various methods, which are disclosed in such as Jpn. Pat. Appln. KOKAI Publication No. 10-319488 (first method), Jpn. Pat. Appln. KOKAI Publication No. 2001-128112 (second method) and Jpn. Pat. Appln. KOKAI Publication No. 11-271638 (third method), are known.

The first method changes a background color and a character color at a character display part in accordance with the brightness of an image and facilitates viewing of the image and character information when displaying the image and the character information on a liquid crystal monitor, in a camera with the liquid crystal monitor.

The second method displays in a monitor an area, which is printed by a printer, and gives a print image to a camera operator at the time of photographing in a camera with a printer.

The third method detects a color and brightness of a surrounding image of a pointer and sets the color and brightness of the pointer based on that detected information when projecting the pointer onto an observation image captured by a microscope.

### BRIEF SUMMARY OF THE INVENTION

According to an aspect of the present invention, there is provided with an imaging device for a microscope which has a simple configuration and can realize a secure visual recognition of photograph information of an observation image with diversification of a sample and diversification of an observation method being assured.

An imaging device according to a first aspect of the present invention is characterized by comprising: an electronic camera which images an observation image captured by the microscope; a display which displays the observation image imaged by the electronic camera and photograph information of the observation image; and a display setting portion which controls the display and sets display of the photograph information.

An imaging device according to a second aspect of the present invention is characterized by comprising: an electronic camera which images an observation image captured by the microscope; and a display which displays the observation image imaged by the electronic camera and a plurality of sets of photographic information concerning the observation image.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for illustrating a configuration of a microscope system to which the present invention is applied;

FIG. 2 is a block diagram showing a configuration of an imaging device for a microscope according to a first embodiment of the present invention;

FIG. 3 is a view showing a display example of imaging information displayed on a display depicted in FIG. 2;

FIG. 4 is a view showing another display example of the imaging information displayed on the display depicted in FIG. 2;

FIG. 5 is a view showing still another display example of the imaging information displayed on the display depicted in FIG. 2;

FIG. 6 is a block diagram showing a configuration of an imaging device for a microscope according to a second embodiment of the present invention;

FIG. 7 is a view showing a display example of imaging information displayed on a display depicted in FIG. 6;

FIG. 8 is a block diagram showing a modification of the imaging device for a microscope according to the second embodiment depicted in FIG. 6;

FIG. 9 is a histogram diagram showing an example of a histogram computed by a histogram computing unit in FIG. 8;

FIG. 10 is a view showing a display example of imaging information displayed on a display in FIG. 8;

FIG. 11 is a block diagram showing a configuration of an imaging device for a microscope according to a third embodiment of the present invention;

FIG. 12 is a view showing a display example of imaging information displayed on a display in FIG. 11;

FIG. 13 is a block diagram showing a configuration of an imaging device for a microscope according to a fourth embodiment of the present invention; and

FIG. 14 is a view showing an example of display pattern information associated with a color, a line type and a line width.

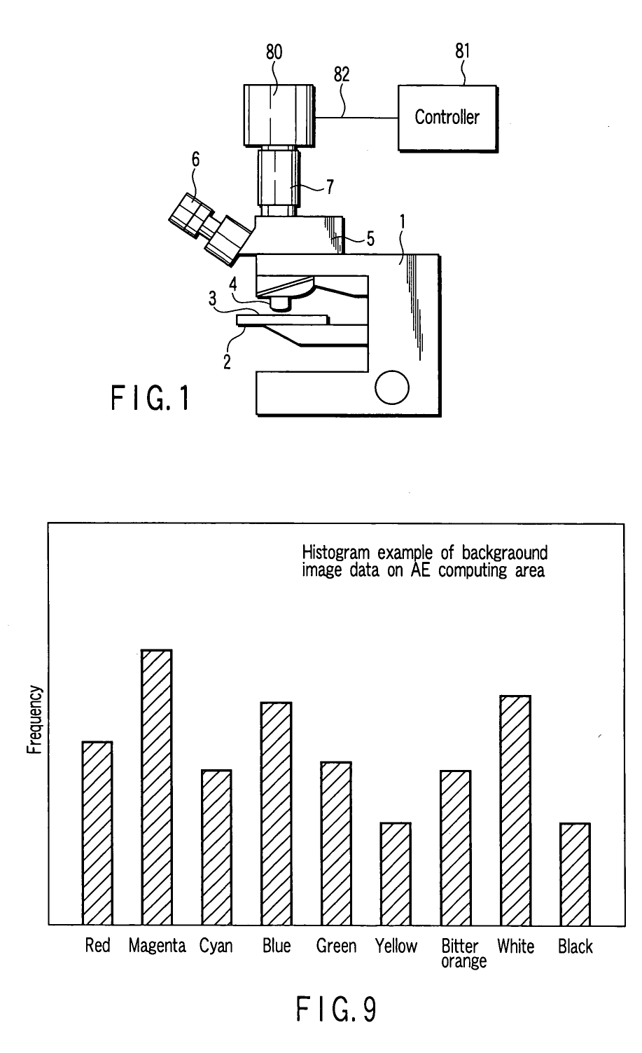

### DETAILED DESCRIPTION OF THE INVENTION

Embodiments according to the present invention will now be described in detail hereinafter with reference to the accompanying drawings.

First, preparatory for explanation of an imaging device for a microscope (Hereinafter, referred to only an “imaging device”) according to first to fourth embodiments of the present invention, a microscope system to which the present invention is applied will be briefly explained.

An objective lens 4 opposed to a sample 3 on a stage 2 is arranged in a microscope main body 1. Further, on an observation optical axis through the objective lens 4, an eyepiece unit 6 is arranged through a trinocular tube unit 5, and a camera head 80 containing an electronic camera is also arranged through an image formation lens unit 7. A controller 81 is connected to the camera head 80 via a connection cable 82.

With the above-described configuration, when an observer operates the microscope main body 1 and observes the sample 3, the observation image is led to the eyepiece unit 6 through the objective lens 4 and the trinocular tube unit 5 and it is directly observed through the eyepiece unit 6. At the same time, an observation image captured by the objective lens 4 is led to the camera head 80 having the imaging device through the image formation lens unit 7, and the observation image is captured as a real time live image through the controller 81 as will be described later, thereby enabling observation based on the live image.

The embodiments of the imaging device characterized by the present invention will now be described.

### First Embodiment

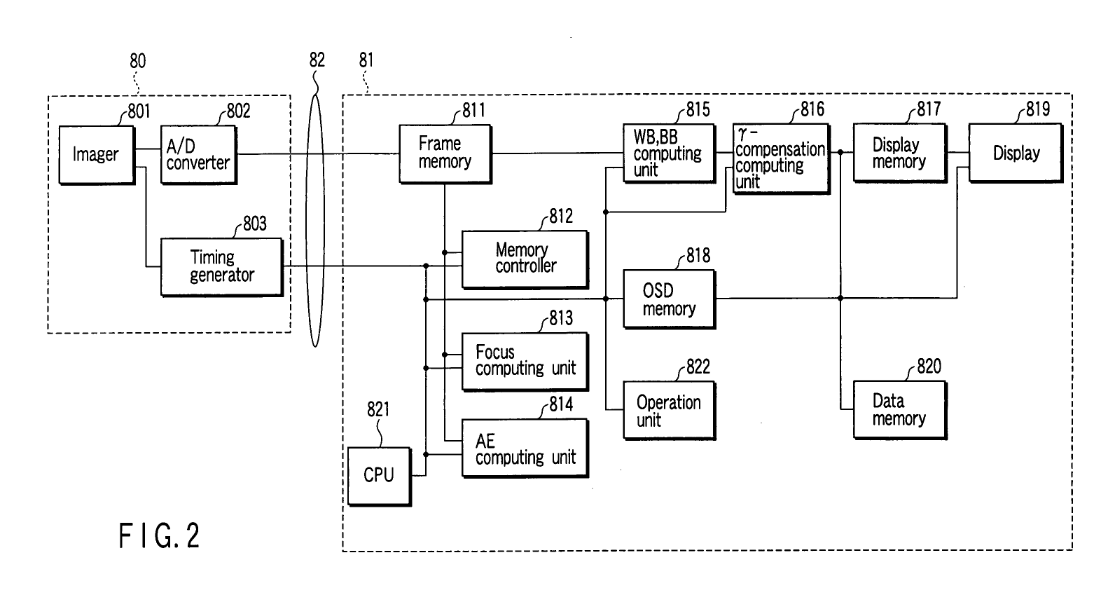

FIG. 2 is a view showing the imaging device according to the first embodiment of the present invention. The imaging device according to the first embodiment includes the camera head 80 and the controller 81. The camera head 80 includes an imager 801, an A/D (analog/digital) converter 802 and a timing generator 803, and the camera head 80 is connected to the controller 81 through the connection cable 82. The imager 801 converts an incident light ray from the objective lens 4 of the microscope main body 1 into an electrical signal. The A/D converter 802 converts an analog signal outputted from the imaging device 801 into a digital signal. The timing generator 803 generates a drive timing of the imager 801.

The controller 81 includes a frame memory 811, a memory controller 812, a focus computing unit 813, an AE computing unit 814, a WB/BB computing unit 815, and γ-compensation computing unit 816. Furthermore, the controller 81 includes a display memory 817, an OSD (On Screen Display) memory 818, a display memory 817, a display 819 and a data memory 820. The frame memory 811 memorizes photographed image data which is an A/D-converted observation image. The memory controller 812 controls a write/read address of the frame memory 811. The focus computing unit 813 specifies a read address by using the memory controller 812, reads the photographed image data and performs a focus arithmetic operation. The AE computing unit 814 carries out a photometric computation. The WB/BB computing unit 815 computes white balance (which will be referred to as WB hereinafter) and black balance (which will be referred to as BB hereinafter). The display memory 817 accumulates image data in order to display an image. The OSD memory 818 overwrites respective photograph information computed by the focus computing unit 813, the AE computing unit 814, the WB/BB computing unit 815 and the γ-compensation computing unit 816 on the image data, and displays a result. The display 819 superimposes and displays the image data in the display memory 817 and the OSD memory 818. The data memory 820 records a picked-up photographed image (observation image).

Moreover, the controller 81 further includes a CPU 821, which controls the entire electronic camera, and an operation unit 822 from which an observer performs various settings of photographing or the camera.

The controller 81 is as typified by, e.g., a personal computer (PC). The display 819 corresponds to a monitor, the operation unit 822 corresponds to a mouse and a keyboard, the data memory 820 corresponds to a storage device such as a hard disk, the CPU 821 and the computing units 813, 814, 815 and 916 correspond to a CPU (central processing unit), and the display memory 817 and the OSD memory 818 correspond to an internal memory or a virtual memory.

In the above-described configuration, when observing and photographing the sample 3, an observer first operates the microscope main body 1, and observes the sample 3. Then, its observation image is captured into the camera head 80 through the image formation lens unit 7, and displayed on the display 819 as will be described later. As a result, a real time live image can be observed. At this moment, the observer sets photograph conditions by manipulating the operation unit 822, and records the observation image in the data memory 820 according to needs.

That is, when the observer operates the operation unit 822 of the controller 81, the timing generator 803 in the camera head 80 is driven, and a photographing timing is thereby controlled. With this timing, the observation image of the sample 3 image by the objective lens 4 is captured by the imaging device 81 and converted into an electrical signal. This electrical signal is analog/digital-converted by the A/D converter 802, and then inputted to the controller 81 through the connection cable 82 as digital image data.

The image data supplied to the controller 81 is memorized in the frame memory 811. The memory controller 812 controls a write/read address of the frame memory 811, and memorizes the image data from the camera head 80 into the frame memory 811. At the same time, the image data is transferred to the display memory 817 through the WB/BB computing unit 815 and the γ-compensation computing unit 816, and a real time live image is displayed on the display 819. At this moment, in a period of the real time image transfer from the frame memory 811 to the display memory 817, various kinds of information concerning photographing are computed and acquired from the image data.

Additionally, the memory controller 812 transmits the image data to the focus computing unit 813, the AE (Automatic Exposure) computing unit 814 and the WB/BB computing unit 815 in a period of image transfer from the frame memory 811 to the display memory 812, e.g., a blanking period of a vertical synchronization signal. The focus computing unit 813 uses image data in a preset focus computing area to compute a contrast value obtained by, e.g., a sum of squares of differences of brightness data of adjacent pixels or the like.

The AE computing unit 814 uses image data in a preset AE computing area to judges whether the current exposure time is good or bad based on a sum total of brightness data in the area or the like. Each judgment result is transmitted to the CPU 821, and the timing generator 803 in the camera head 80 controls a drive timing of the imager 801 so as to optimize the exposure time. Further, the WB/BB computing unit 815 uses image data in a preset WB/BB computing area to perform gain processing to data of R and B in the image data read from the frame memory in such a manner that data of RGB in that area become equal. The processed data is subjected to γ-compensation in the γ-compensation computing unit 816, and then memorized in the display memory 817. Specifically, the processing is as follows.

WB processing in the WB/BB computing unit 815 is processing to photograph a white sample with respect to a set area in an image (for example, it is determined as a central part 500×500 of an image size 1000×1000) and acquire RGB data of that image. Since the white sample is photographed, a value R, a value G and a value B in the set area must have the same value (because the color is white in case of the same value), but they are actually different from each other due to a spectral characteristic of the imaging device (which will be referred to as a CCD hereinafter) and a color temperature of a light source. For example, it is assumed that a pixel R, a pixel G and a pixel B in the area have the following average values:

average value of R=90;

average value of G=100; and

average value of B=110.

Since values of the white image that R=G=B should be established have the above values, they must be corrected. Determining the value G as a reference, they all have the same value when the value of R is multiplied by 1.1 and the value of B is multiplied by 0.9.

Thus, assuming that the R gain and the B gain are set as follows:

R gain=1.1; and

B gain=0.9, value of R after adjustment=R×R gain=90×1.1=99, value of G after adjustment=G=100, and value of B after adjustment=B×B gain=110×0.9=99.

Thereafter, every time a sample which is not white is photographed, the WB computing unit executes processing by multiplying the above-described gains with respect to the respective pixels R and B in all RGB pixels in an image.

BB processing in the WB/BB computing unit 815 is processing to perform correction of a black color. Specifically, a sample with a black color is photographed, and resulting RGB is processed to be black.

For example, it is assumed that the following values are obtained:

R average value=15;

G average value=5; and

B average value=8

Although R=G=B=0 is established in case of the black color, it is rare that the relationship completely becomes 0 because of existence of a noise component. Thus, the value G which is 5 is determined as a noise component. That is, the RGB values in which the noise component is eliminated can be obtained by subtracting the following noise component from each RGB value:

noise component=5

That is, the following noise correction values are determined and each RGB noise correction value becomes an image after completion of the BB processing:

R noise correction value=R−noise component=15−5=10

G noise correction value=G−noise component=5−5=5

B noise correction value=B−noise component=8−5=3

Upon completion of the WB processing and the BB processing, the image data read from the frame memory 811 is subjected to γ-compensation in the γ-compensation computing unit 816, and memorized in the display memory 817. Here, the γ-processing will be explained.

The γ-processing is processing carried out because the sensitivity of the CCD is different from the sensitivity of the monitor. Although the CCD produces an output, which is in proportion to an input light quantity by a value within a range of 0 to 255, an input value and an output value are non-linear in the monitor. Here, the output value of the monitor means a brightness value when the light is emitted from a given point in the monitor. In other words, this means how the output value is seen by human eyes in the monitor.

Therefore, when the RGB values acquired from the CCD are displayed as they are, how these values are seen differs depending on a case that an image is viewed through the monitor and a case that an actual sample is directly observed by human eyes even if the WB processing or the BB processing is performed.

Thus, the following conversion table is prepared for each value of RGB.

| RGB values | Values after the γ processing |
|---|---|
| 1 | 0 |
| 10 | 10 |
| 20 | 20 |
| 50 | 45 |
| 100 | 90 |
| 150 | 140 |
| 200 | 180 |
| 230 | 220 |
| 250 | 225 |
| 255 | 230 |

According to this table, an output from the γ-compensation computing unit 816 becomes 0 when the RGB value is 1, an output from the γ-compensation computing unit 816 becomes 10 when the RGB value is 10, and an output from the γ-compensation computing unit 816 becomes 45 when the RGB value is 50. It is to be noted that values after the γ-processing are usually associated with each of the RGB values 0 to 255, but the above table shows only a part.

By performing such γ-processing, the same image as that when an actual sample is directly observed by human eyes is displayed on the display (monitor).

On the other hand, the photograph information obtained by the focus computing unit 813, the AE computing unit 814 and the WB/BB computing unit 815 is read to the CPU 821 and written in the OSD memory. The data written in the display memory 817 and the OSD memory 818 are superimposed and displayed on the display 819, and an observer can thereby confirm a result.

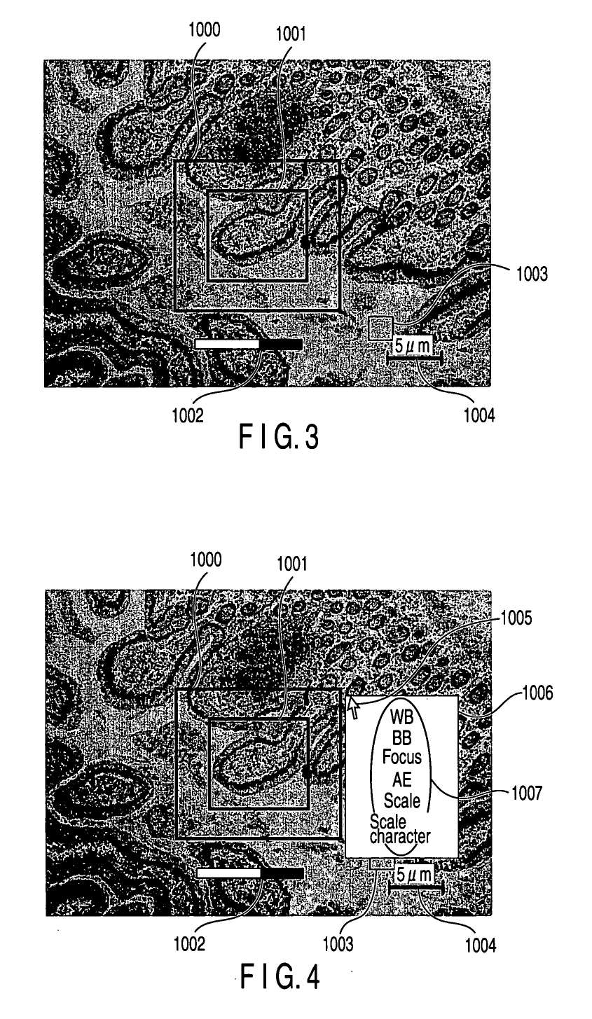

The observer performs observation and photographing by operating the operation unit 822 from the image data and the photograph information displayed on the display 819 so as to satisfy the conditions optimal for photographing. Here, the image data is selectively recorded in the data memory 820. The concrete photograph information written in the OSD memory 818 is shown in, e.g., FIG. 3.

The photograph information shown in FIG. 3 indicates image data as the observation image displayed on the display 819 and the image information. The photograph information shown in FIG. 3 is an example when the data in the display memory 817 and the OSD memory 818 are superimposed and displayed. An optimal exposure time is computed by using the brightness data in the area of an AE computing area 1000. A current contrast value is computed by using the data in the area of a focus computing area 1001. The computed contrast value is displayed on an indicator display 1002 so as to facilitate a visual recognition as shown in FIG. 3. The indicator display 1002 is shown as a bar chart that a width is greatly shifted to right as the contrast value is large, and a current contrast value and a past maximum value are displayed.

Thus, the observer drives the stage 2 of the microscope main body 1 while watching the indicator display 1002. In this case, a most shifted position in the indicator display 1002 is a pint position. Furthermore, gains of R and B are determined based on data of R, G and B in a WB/BB computing area 1003.

It is to be noted that, in FIG. 3, a scale display 1004 can be turned on/off by manipulating the operation unit 822, and is displayed onto a live image and photographed image or either of them. Moreover, the scale display 1004 displays a correct length by inputting, e.g., a comprehensive magnification of the microscope. Since the photograph information is superimposed on the observation image and is displayed as shown in FIG. 3, the photograph information might have the same color as the observation image depending on an image on the background if, for example, a frame is black at the time of fluorescent observation, thereby deteriorating a visual recognition property. In this case, an observer operates the operation unit 822 so that a line color, a line width a line type in the photograph information display can be arbitrarily changed, a setting adjustment operation is thereby performed so as to maintain a desired visual recognition property.

FIG. 4 is an example of a method of changing the photograph information display, and shows a screen of the display 819. An observer operates the operation unit 822 and sets a cursor 1005 on an item from which a photograph information display method should be changed, and manipulates the operation unit 822, thereby display a setting menu 1006. Moreover, the cursor 1005 changes a color, a line type and a line width of a desired item by selecting that item from items 1007 in the setting menu 1006. As a result, changes in the color, the line type or the line width are reflected to desired photograph information.

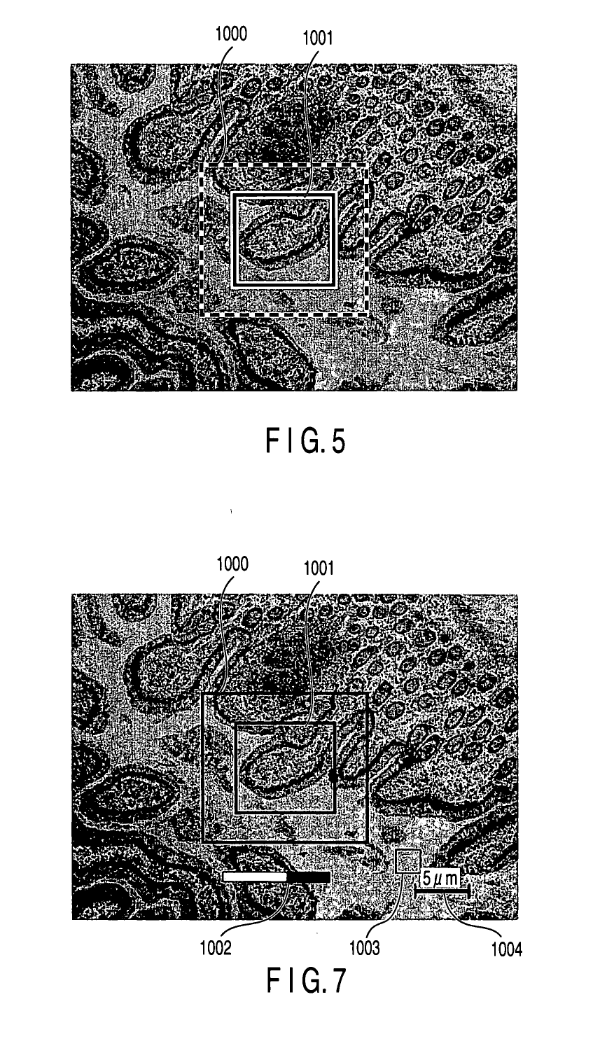

Additionally, it is unnecessary that the photograph information of the photographed image does not have a single color. For example, a bordering 1001 can be provided by using a plurality of colors along a longitudinal direction of a line segment or striping 1000 can be provided by using them along a direction vertical to the longitudinal direction as shown in FIG. 5. Furthermore, the visual recognition property can be further increased by changing a color with time.

As described above, in the imaging device according to the embodiment, photograph information of an observation image captured by the microscope main body 1 is displayed on the display 819 of the controller 81 together with an observation image imaged by the camera head 80, and display of imaging information of the observation image can be selectively set.

With this configuration, by enabling setting of display of the photograph information displayed on the display 819 in accordance with, e.g., a type of a sample or an observation method, the photograph information can be displayed with the excellent visual recognition property without burying the photograph information in a background image of the observation image. As a result, highly accurate observation of the observation image can be readily realized.

According to the device, display is automatically changed in real time even if the sample 3 is moved or the observation method is changed, thereby removing the burden on the observer. Therefore, the usability is improved, and the simple and easy operation is enabled. Additionally, a plurality of sets of photograph information can be included to one photograph information display, thereby improving the visual recognition property.

### Second Embodiment

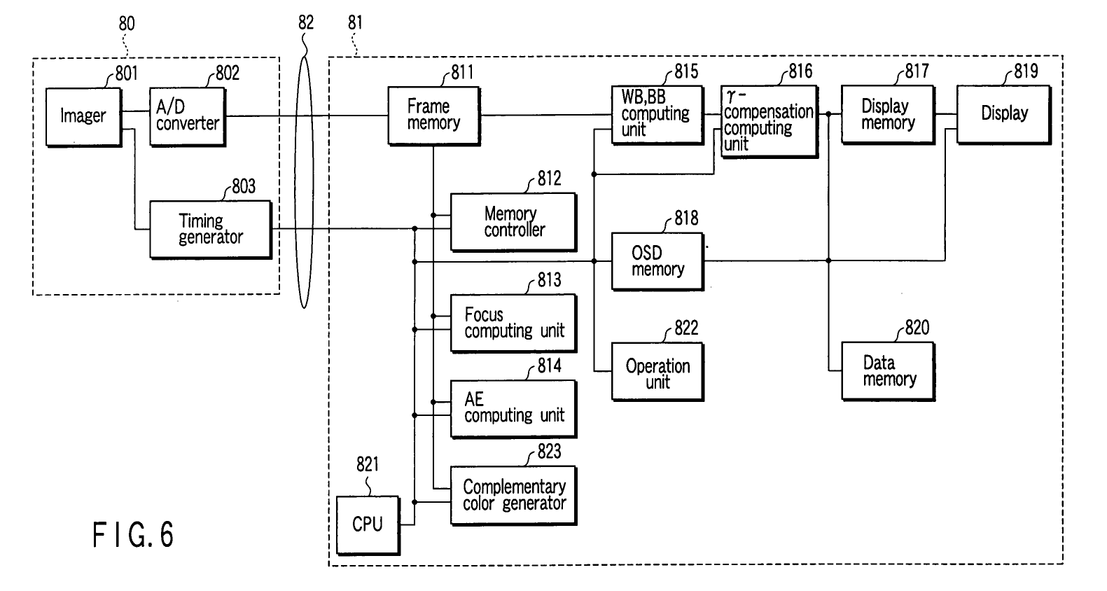

FIG. 6 is a view showing an imaging device according to a second embodiment of the present invention. In FIG. 6, like reference numerals denote parts equal to those in the first embodiment shown in FIG. 2 for the convenience's sake, thereby omitting their detailed explanation.

That is, an imaging device according to the second embodiment further includes a complementary color generator 823 arranged at an output of the frame memory 811. The complementary color generator 823 selectively drives and controls through the CPU 821 in cooperation with the manipulation in the operation unit 822.

With the above-described configuration, the complementary color generator 823 reads a background image corresponding to a position where photograph information of the focus computing unit 813, the AE computing unit 814 and the WB/BB computing unit 815 is displayed on the screen from the frame memory 811, and computes photograph information data based on the following expression (1):

(R′xy, G′xy, B′xy)=(255, 255, 255)−(Rxy, Gxy, Bxy) (1)

where (Rxy, Gxy, Bxy) is background image data (respective eight bits of R, G and B) in a screen (x, y), and (R′xy, G′xy, B′xy) is photograph information display data (respective eight bits of R, G and B) in the screen (x, y).

The computed photograph information data is written in the OSD memory 818 by the CPU 821, superimposed at the display 819 together with the image data in the display memory 817, and displayed as shown in FIG. 7.

By determining photographed image data as a complementary color of the background image data, the photograph information data cannot be buried in the background when any background image is used, and the visual recognition property can be further improved.

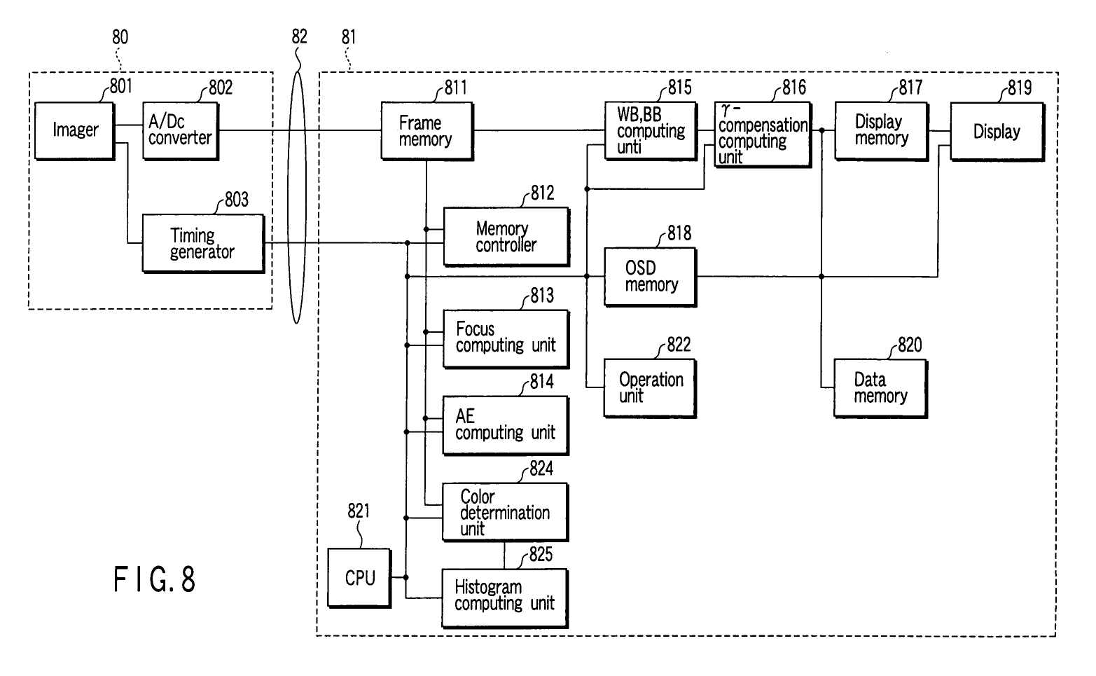

As shown in FIG. 8, the imaging device according to the second embodiment may include a color determination unit 824 which determines a color for each one pixel in the background data and a histogram computing unit 825 which computes a histogram of a color determined by the color determination unit 824 at an output of the frame memory 811 in place of the complementary color generator 823 shown in FIG. 6. In this case, substantially the same advantages as those in the configuration shown in FIG. 6 can be expected. However, in FIG. 8, like reference numerals denote parts equal to those in FIG. 6 for the convenience's sake, thereby omitting their detailed explanation.

With the above-described configuration, the color determination unit 824 reads a background image corresponding to a position where the photograph information of the focus computing unit 813, the AE computing unit 814 and the WB/BB computing unit 815 is displayed on the screen from the frame memory 811, and determines a color for each one pixel. As colors used in a judgment, there are used nine types, e.g., seven colors, i.e., red, magenta, cyan, blue, green, yellow and orange as well as white (e.g., not less than a brightness value 230) and black (e.g., not more than a brightness value 30). Color information data determined in the color determination unit 824 is supplied to the histogram computing unit 825, and a histogram is computed in accordance with each set of photograph information as shown in FIG. 9.

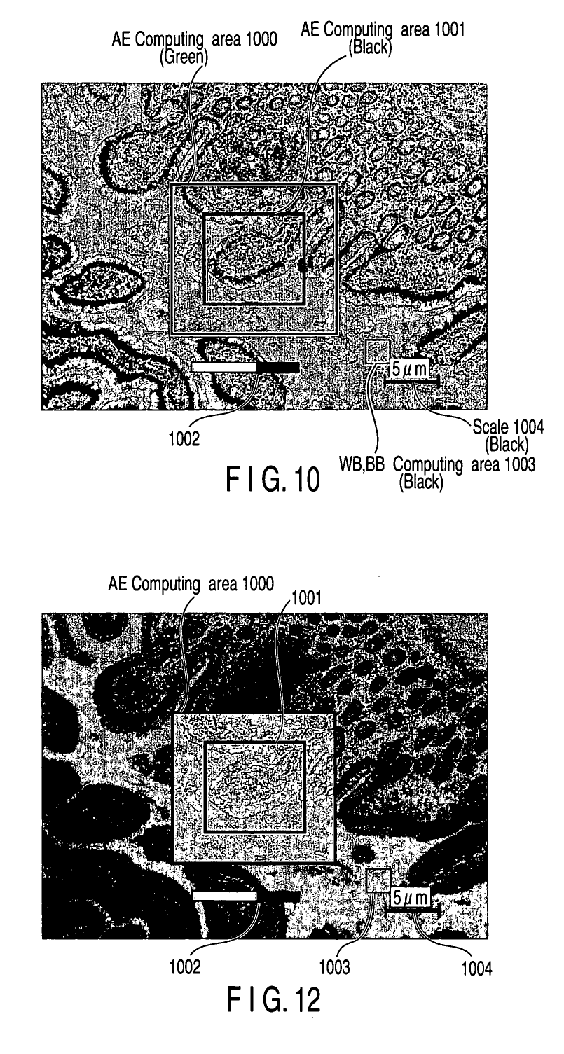

The CPU 821 uses a complementary color of a most frequently used color in accordance with each photograph information based on the histogram and writes data in the OSD memory 818 so as to display the photograph information. The photograph information data written in the OSD memory 818 is combined with the background data of the display memory 817 in the display 819, and a result is displayed as shown in, e.g., FIG. 10.

It is to be noted that the number of colors used in the judgment in the color determination unit 824 is not restricted to nine in this example, and it can be arbitrarily set. Further, although white and black are determined based on the brightness values, their threshold values (white: 230 or more, black: 30 or less) can be also arbitrarily set.

### Third Embodiment

FIG. 11 is a view showing an imaging device according to a third embodiment of the present invention. In FIG. 11, like reference numerals denote parts equal to those in the first embodiment shown in FIG. 2 for the convenience's sake, thereby omitting their detailed explanation.

The imaging device according to the third embodiment includes a display pattern generator 826 which is arranged at the output of the frame memory 811 and generates a pattern to display photograph information. A display pattern is set by selectively driving and controlling the display pattern generator 826 through the CPU 821 in cooperation with the manipulation in the operation unit 822.

With the above-described configuration, the display pattern generator 826 reads a background image corresponding to a position where photographed image of the focus computing unit 813, the AE computing unit 814 and the WB/BB computing unit 815 is displayed on the screen from the frame memory 811, and generates a display pattern in accordance with the following expression (2):

(R′xy, G′xy, B′xy)=(Rxy, Gxy, Bxy)×k (2)

where (Rxy, Gxy, Bxy) is background image data (respective eight bits of R, G and B) in a screen (x, y), (R′xy, G′xy, B′xy) is photograph information display data (respective eight bits of R, G and B) in the screen (x, y), and k is a display coefficient such as a pattern or hatching. For example, k=0 means that an image is not processed, k=½ means that each of RGB is reduced to ½ and darkened, and k is determined as 0 in a photograph information area and as ½ out of the photograph information area.

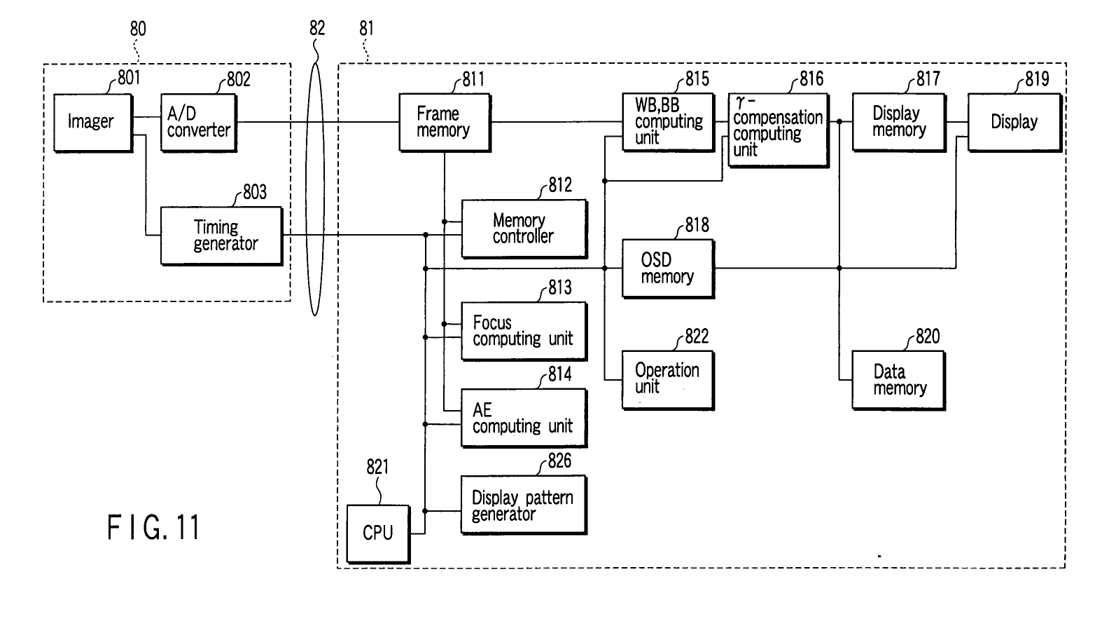

The photograph information display data is written in the OSD memory 818 together with the photograph information by the CPU 821. The photograph information data written in the OSD memory 818 is combined with background data of the display memory 817 and displayed on the display 819 as shown in FIG. 12.

FIG. 12 is an example when the AE computing area is displayed. Besides, when the focus computing area is to be displayed, the operation unit 822 is operated and the non-illustrated cursor is used to enable the focus computing area. As a result, the inside of the focus computing area is changed to be displayed as a regular image, and the outside of the area is changed to be displayed in such a manner that levels of R, G and B become ½.

It is to be noted that a pattern display coefficient k which is multiplied to the image data in or out of the photograph information area is arbitrarily set, for example.

Further, the visual recognition property of the display pattern can be increased by applying hatching and the like. Furthermore, in regard to items to be displayed, one type of the item like those in this embodiment is not selectively displayed, but different patterns may be allocated to the respective photograph information areas in advance so that a judgment in or out of each area can be enabled even if the items are simultaneously displayed.

### Fourth Embodiment

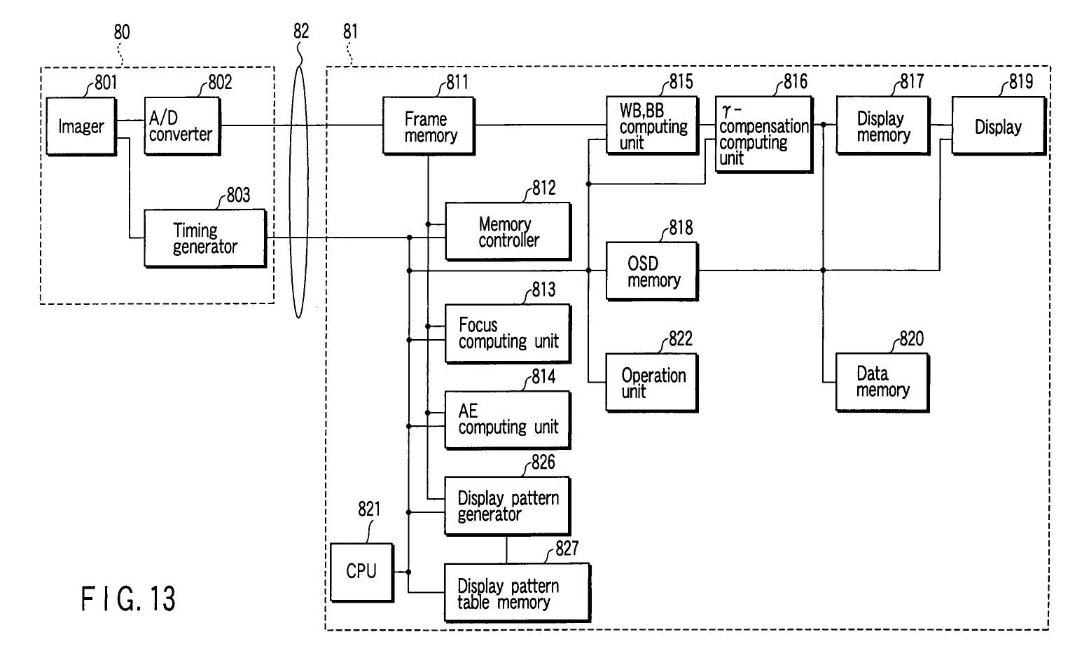

FIG. 13 is a view showing a imaging device according to a fourth embodiment. In FIG. 13, however, like reference numerals denote parts equal to those in the first and third embodiments shown in FIGS. 2 and 11 for the convenience's sake, thereby omitting their detailed explanation.

An imaging device according to the fourth embodiment includes a display pattern generator 826 which generates a pattern used to display photograph information and a display pattern memory 827 which memorizes desired display patterns as a table, both of which portions are arranged at the output of the frame memory 811. The display pattern generator 826 is selectively driven and controlled based on a memorized display pattern in the display pattern memory 827 through the CPU 821 in cooperation with the manipulation of the operation unit 822.

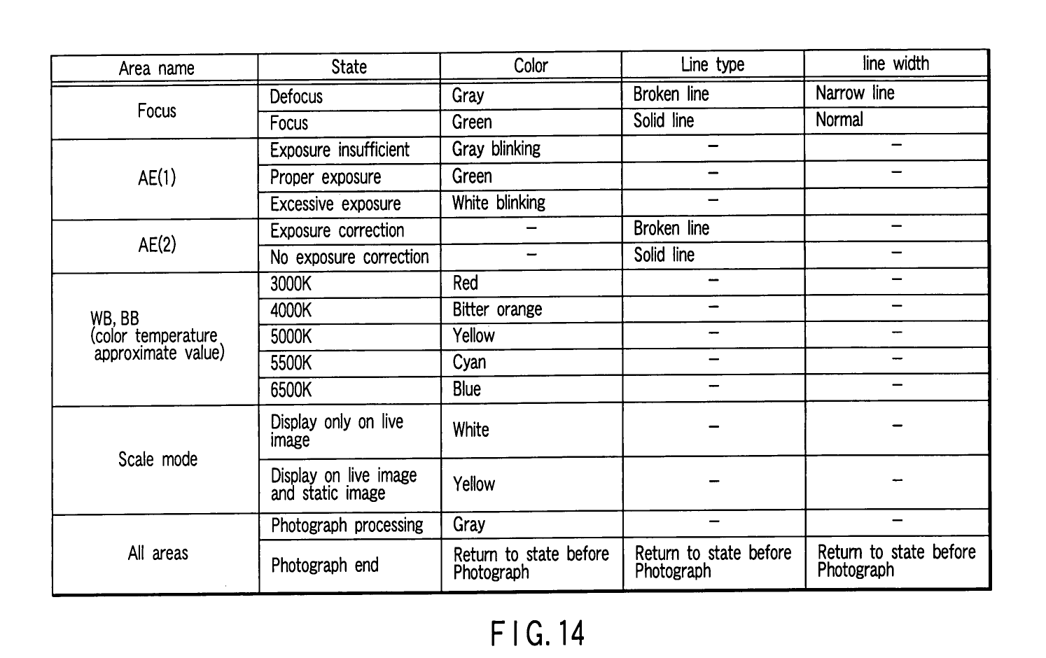

With the above-described configuration, the display pattern generator 826 displays computing areas obtained from the focus computing unit 813, the AE computing unit 814 and the WB/BB computing unit 815, and also displays information such as focus/defocus at the same time in case of, e.g., a focus area. As shown in, e.g., FIG. 14, the display pattern generator 826 reads display pattern information associated with a color, a line type and a line width from a display pattern table memory 827 memorizing this information therein, and corresponding information is thereby displayed.

That is, in regard to focus, a focus position and a defocus position are determined. At, e.g., the defocus position, the focus computing area is indicated by a gray broken line (thin line). At the focus position, it is indicated by a green solid line. As a result, a focus state can be also confirmed as well as the focus area by using the color, the line type and the line width.

An item of AE(1) shows an exposure state. For example, insufficient exposure is indicated by gray flashing, proper exposure is indicated by green light emission, and excessive exposure is indicated by white flashing. Consequently, an observer can take a picture with the correct brightness by giving a proper value to a shutter speed.

An item of AE(2) shows presence/absence of an exposure correction. For example, a line of a photometric area is indicated by a broken line when the exposure correction is carried out, and it is indicated by a solid line when the exposure correction is not effected.

Simultaneously using the item of AE(1) and the item of AE(2) means, e.g., the exposure is corrected, and the insufficient exposure is indicated by flashing an exposure area surrounded by the gray broken line.

An item of WB/BB shows a temperature by coloring a light source color temperature which is considered to be closest to the computed gains of R and B in a color temperature range of 3000K to 6500K. At this moment, in regard to a scale, since there are a state of only displaying on a live image and a state of displaying on a live image + displaying on a photographed image (observation image), white indicates a case of only the live image and yellow indicates a case of displaying on both the live image and the photographed image (observation image), for example.

Display during photographing processing that acceptance of inputs to the operation unit 822 is inhibited is provided in gray with respect to the entire information display area, which means any item cannot be set and changed. Moreover, upon completion of the photographing processing, a white frame of a solid line returns to a flashing state if a state before the photographing processing, e.g., an AE state before photographing corresponds to no exposure correction and excessive exposure.

The display pattern information shown in FIG. 14 is just an example, and a color, a line type and a line width in each area can be arbitrarily set. Additionally, the items and the numbers of sets of the photograph information are not restricted to the information depicted in FIG. 14.

It is to be noted that the camera head 80 and the controller 81 are separately provided in the first to fourth embodiments, but they may be configured in an integral camera configuration.

Further, the controller 81 has been described above in the example that it is constituted by using a PC, but it is not restricted thereto, and it can be used as a standalone type by utilizing a dedicated controller. Furthermore, a reduction in size is possible, thereby improving the usability.

The following inventions can be extracted from the above-mentioned embodiments. It is to be noted that each of the following inventions may be applied solely or may be applied in combination with the others.

An imaging device according to a first aspect of the present invention is characterized by comprising: an electronic camera which images an observation image captured by the microscope; a display which displays the observation image imaged by the electronic camera and photograph information of the observation image; and a display setting portion which controls the display and sets display of the photograph information.

The photograph information displayed on the display can be displayed with the excellent visual recognition property without being buried in a background image of the observation image when its display state is variably set in accordance with, e.g., a sample type or an observation method. Therefore, it can contribute to highly accurate observation of the observation image.

An imaging device according to a second aspect of the present invention is characterized by comprising: an electronic camera which images an observation image captured by the microscope; and a display which displays the observation image imaged by the electronic camera and a plurality of sets of photographic information concerning the observation image.

Displaying a plurality of sets of the photograph information in the display enables observation of the observation image based on a plurality of sets of the photographed image. Therefore, it can contribute to highly accurate observation of the observation image.

The following embodiments are preferable in the above first and second aspects.

(1) The photograph information of the observation image includes at least one of a photometry, a focus, a color balance and a scale. Confirmation of the observation image based on the photograph information is enabled.

(2) The display setting portion sets at least one of a line color, a line width and a line type. A visual recognition of the photograph information is simply and easily enabled.

(3) The imaging device further comprises a complementary color generator which sets a display color of (a plurality of sets of) the photograph information to a complementary color of a background image of the observation image.

(4) The imaging device further comprises a color determination unit which determines a color for each one pixel of a background image of the observation image and a histogram computing unit which computes a histogram with respect to each color determined by the color determination unit.

(5) The display controller sets a display color of (a plurality of sets of) the photograph information based on the computed histogram.

(6) The imaging device further comprises a display pattern generator which generates a pattern used to display (a plurality of sets of) the photograph information.

(7) The imaging device further comprises a display pattern memory which memorizes a predetermined display pattern as a table.

The present invention is not restricted to each of the foregoing embodiments, and various modifications can be carried out within the scope thereof on embodying stages. Moreover, the foregoing embodiments include the inventions on various stages, and a variety of inventions can be extracted from appropriate combinations of a plurality of disclosed configurations.

For example, even if some configurations are deleted from all the configurations shown in each embodiment, when the problems mentioned in the section “problems to be solved by the invention” can be solved and the advantages mentioned in the section “effects of the invention” can be obtained, a configuration that these configurations are deleted can be extracted as the invention.

As described above, according to the embodiments of the present invention, it is possible to provide the imaging device which has a simple configuration and can realize a secure visual recognition of photograph information of an observation image while assuring diversification of a sample and diversification of an observation method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An imaging device for a microscope, comprising:
an electronic camera which images an observation image captured by the microscope;
a display which displays the observation image imaged by the electronic camera and photograph information of the observation image; and
a display setting portion which controls the display and sets display of the photograph information.

2. The device according to claim 1, wherein the display setting portion sets at least one of a line color, a line width and a line type.

3. The device according to claim 1, the photograph information of the observation image includes at least one of a photometry, a focus, a color balance and a scale.

4. The device according to claim 3, wherein the display setting portion sets at least one of a line color, a line width and a line type.

5. The device according to claim 1, further comprising a complementary color generator which sets a display color of the photograph information to a complementary color of a background image of the observation image.

6. The device according to claim 10, further comprising:
a color determination unit which determines a color for each one pixel of a background image of the observation image; and
a histogram computing unit which computes a histogram for each color determined by the color determination unit.

7. The device according to claim 6, wherein the display controller sets a display color of a plurality of sets of the photograph information based on the computed histogram.

8. The device according to claim 1, further comprising a display pattern generator which generates a pattern for displaying a plurality of sets of the photograph information.

9. The device according to claim 8, further comprising a display pattern memory which memorizes a predetermined display pattern as a table.

10. An imaging device for a microscope comprising:
an electronic camera which images an observation image captured by the microscope; and
a display which displays the observation image imaged by the electronic camera and a plurality of sets of photographic information concerning the observation image.

11. The device according to claim 10, wherein at least one of a line color, a line width and a line type displayed on the display of the plurality of sets of photograph information is settable.

12. The imaging device according to claim 10, wherein a plurality of sets of the photograph information concerning the observation image includes at least one of a photometry, a focus, a color balance and a scale.

13. The device according to claim 12, wherein at least one of a line color, a line width and a line type displayed on the display of the plurality of sets of photograph information is settable.

14. The device according to claim 1, further comprising a complementary color generator which sets a display color of the photograph information to a complementary color of a background image of the observation image.

15. The device according to claim 10, further comprising:
a color determination unit which determines a color for each one pixel of a background image of the observation image; and
a histogram computing unit which computes a histogram for each color determined by the color determination unit.

16. The device according to claim 15, wherein the display controller sets a display color of a plurality of sets of the photograph information based on the computed histogram.

17. The device according to claim 10, further comprising a display pattern generator which generates a pattern used to display a plurality of sets of the photograph information.

18. The device according to claim 17, further comprising a display pattern memory which memorizes a predetermined display pattern as a table.
